(19) United States
(12) Patent Application Publication
(10) Pub. No.: US 2024/0231599 A9
(43) Pub. Date: Jul. 11, 2024

(54) A COMPUTER A SOFTWARE MODULE ARRANGEMENT, A CIRCUITRY ARRANGEMENT, A USER EQUIPMENT AND A METHOD FOR AN IMPROVED USER INTERFACE CONTROLLING MULTIPLE APPLICATIONS SIMULTANEOUSLY

(71) Applicant: Telefonaktiebolaget LM Ericsson (publ), Stockholm (SE)

(72) Inventors: Andreas KRISTENSSON, SÖDRA SANDBY (SE); Alexander HUNT, TYGELSJÖ (SE); Fredrik DAHLGREN, LUND (SE)

(21) Appl. No.: 18/276,030

(22) PCT Filed: Mar. 3, 2021
(86) PCT No.: PCT/EP2021/055342

§ 371 Date: Aug. 5, 2023

(51) Int. Cl. G06F 3/0488; G06F 3/01; G06F 3/0484

(52) U.S. Cl. CPC G06F 3/0488; G06F 3/017; G06F 3/0484

(57) ABSTRACT

A user equipment comprising at least one side sensor and a controller, wherein the side sensor configured to receive touchless user input, thereby providing a touchless input area, and wherein the controller is configured to: detect a group of objects in the touchless input area; determine a number of objects in the group of objects; determine an application associated with the number of objects; receive input based on the detected group of objects; and determine an action associated with the input for the application associated with the number of objects.

### TECHNICAL FIELD

The present invention relates to an arrangement, an arrangement comprising computer a software modules, an arrangement comprising circuits, a user equipment and a method for providing an improved and extended user interface, and in particular to an arrangement, an arrangement comprising computer a software modules, an arrangement comprising circuits, a user equipment and a method for providing an improved and extended user interface enabling controlling of multiple applications, for example background applications.

### BACKGROUND

Today's user equipments or mobile devices have touchscreens. These are based on touching the display with one or several fingers, and moving the finger in a certain way can have certain specific meaning, such as touching the screen and moving the finger from the bottom of the screen and upwards on for example an iPhone™ means that the active applications are listed as windows-based icons in the screen that one can as a next step scroll between.

There are sensors added to such mobile devices, e.g. radar that enable gesture recognition or detection of movements in certain parts of the space surrounding the device.

In many applications or navigation scenarios, the touch input is limited by the size of the device display, e.g. scrolling through content that in itself is not related to size of the device display. For example, a smartwatch has a very limited physical size of the display.

In many usage scenarios and for many mobile device applications, the application takes over the complete screen when active, meaning that the area on the touchscreen to potentially control other applications are no longer available, and to be able to control other applications often implies a multi-touch sequence to move to the other application where the current shown application needs to be changed and another application should be selected to be shown on the screen.

There are technologies to identify gestures or movements outside of physical device, e.g. by radar or camera, but these normally are less intuitive from a usage perspective.

There is also a problem in contemporary devices in that the set of inputs possible is relatively limited. For example, the number of gestures that are easy to learn and to execute is limited, severely limiting the usability when executing multiple applications at once.

### SUMMARY

As discussed above, the inventors have realized that as the touchless input area is not restricted by the same physical borders as a touchscreen, other means area available for discerning between different inputs, such as different gestures. The solution according to the teachings herein enables a user to associate a same gesture or other input with different applications, thereby being able to use the same input but for different applications and at the same time, by associating a number of fingers with a specific application. Moreover, the solutions provided are simple and elegant, which is inventive in itself.

As hinted at above, the invention is based on the associating a number of fingers with a specific application, and thereby being able to discern which application a same input is aimed for simply by determining how many fingers is used to provide the input.

An object of the present teachings is thus to overcome or at least reduce or mitigate the problems discussed in the above.

According to one aspect a user equipment is provided, the user equipment comprising at least one side sensor and a controller, wherein the side sensor configured to receive touchless user input, thereby providing a touchless input area, and wherein the controller is configure ed to: detect a group of objects in the touchless input area; determine a number of objects in the group of objects; determine an application associated with the number of objects; receive input based on the detected group of objects; and determine an action associated with the input for the application associated with the number of objects.

This allows for an easy and natural manner for a user to interact with a user equipment controlling multiple applications with a limited user interface and available command set.

In some embodiments the controller is configured to determine a first number of objects and associate the first number of objects with a first application and to determine a second number of objects and associate the second number of objects with a second application.

In some embodiments the at least one side sensor is configured to differentiate between different types of objects and wherein the controller is further configured to determine a type of objects in the group of objects; determine the application associated with the number of objects and with the type of object.

In some embodiments the controller is further configured to determine an order of two types of objects in the group of objects; determine the application associated with the number of objects, the type of object and with the order of objects.

In some embodiments the controller is further configured to determine that the detected object is a finger of a user.

In some embodiments the controller is further configured to determine that the detected object is a pen or stylus.

In some embodiments a first application is a top application and the further applications are background applications. This allows for simultaneous control of a top application in a normal manner (using one finger) while allowing control of background applications) simply by performing the input using more than one finger, thus providing multiple control without having to swap or otherwise switch or activate an application.

In some embodiments, the first application is a top application and at least the second application is also a top application. This enables simultaneous control of different top applications using the same gesture set.

In some embodiments the controller is further configured to determine the number of objects in the detected group of objects by determining a location area for the detected groups of objects.

In some embodiments the controller is further configured to determine the number of objects in the detected group of objects by detecting at least one individual object.

In some embodiments the controller is further configured to receive the input by detecting a gesture and to determine the associated action by executing a command associated with the detected gesture for the application associated with the number of objects.

In some embodiments controller is further configured to receive the input by detecting a location and a distance for the detected group of objects and detecting a movement of the detected group of objects and to determine the associated action by acting for the application associated with the number of objects according to the detected movement.

In some embodiments the controller is further configured to act for the application associated with the number of objects according to the detected movement by: performing an action associated with the option being displayed at a location corresponding to the object when the movement is detected to be towards the user equipment; determining a new option corresponding to a new location of the object when the movement is detected to be along the user equipment; cancelling at least one option when the movement is detected to be away from the user equipment; and by executing a command when the option is associated with such a command.

In some embodiments the user equipment comprises a display, and wherein at least one of the at least one side sensor is arranged adjacent the display, wherein the side sensor is configured to receive touchless user input at a side of the display, thereby providing the touchless input area at the side of the display.

In some embodiments the user equipment comprises an input device, and wherein at least one of the at least one side sensor is arranged adjacent the input device, wherein the side sensor is configured to receive touchless user input at a side of the input device, thereby providing the touchless input area at the side of the input device.

In some embodiments the user equipment comprises the side sensor by being operatively connected to it.

In some embodiments the user equipment is a smartphone, smartwatch or a tablet computer.

In some embodiments the user equipment is a computer being arranged to be operatively connected to a keyboard, a cursor controlling device and/or a display.

According to one aspect a method for use in a user equipment comprising a at least one side sensor configured to receive touchless user input, thereby providing a touchless input area, and wherein the method comprises: detecting a group of objects in the touchless input area; determining a number of objects in the group of objects; determining an application associated with the number of objects; receiving input based on the detected group of objects; and determining an action associated with the input for the application associated with the number of objects.

According to one aspect there is provided a computer-readable medium carrying computer instructions that when loaded into and executed by a controller of a user equipment enables the user equipment to implement any of the methods herein.

According to one aspect there is provided a software module arrangement for a user equipment comprising at least one side sensor configured to receive touchless user input, thereby providing a touchless input area, wherein the a software module arrangement comprises: a software module for detecting a group of objects in the touchless input area; a software module for determining a number of objects in the group of objects; a software module for determining an application associated with the number of objects; a software module for receiving input based on the detected group of objects; and a software module for determining an action associated with the input for the application associated with the number of objects.

According to one aspect there is provided an arrangement adapted to be used in a user equipment comprising at least one side sensor configured to receive touchless user input, thereby providing a touchless input area, and said arrangement comprising: circuitry for detecting a group of objects in the touchless input area; circuitry for determining a number of objects in the group of objects; circuitry for determining an application associated with the number of objects; circuitry for receiving input based on the detected group of objects; and circuitry for determining an action associated with the input for the application associated with the number of objects.

The solution may be implemented as a software solution, a hardware solution or a mix of software and hardware components. Further embodiments and advantages of the present invention will be given in the detailed description.

### BRIEF DESCRIPTION OF THE DRAWINGS

Embodiments of the invention will be described in the following, reference being made to the appended drawings which illustrate non-limiting examples of how the inventive concept can be reduced into practice.

FIG. 1A shows a schematic view of a user equipment according to some embodiments of the present invention;

FIG. 1B shows a schematic view of a user equipment according to some embodiments of the present invention;

FIG. 1C shows a schematic view of a subsection of a user equipment, such as the user equipment of FIG. 1A or FIG. 1B according to some embodiments of the present invention;

FIG. 2A shows the user equipment of FIG. 1A according to some embodiments of the present invention;

FIG. 2B also shows the user equipment of FIG. 1A according to some embodiments of the present invention;

FIG. 3A shows a schematic view of a user equipment according to some embodiments of the present invention;

FIG. 3B shows a schematic view of a user equipment according to some embodiments of the present invention;

FIG. 3C shows a schematic view of a user equipment according to some embodiments of the present invention;

FIG. 3D shows a schematic view of a user equipment according to some embodiments of the present invention;

FIG. 4A shows a schematic view of a user equipment according to some embodiments of the present invention;

FIG. 4B shows a schematic view of a user equipment according to some embodiments of the present invention;

FIG. 4C shows a schematic view of a user equipment according to some embodiments of the present invention;

FIG. 5A shows a schematic view of a user equipment according to some embodiments of the present invention;

FIG. 5B shows a schematic view of a user equipment according to some embodiments of the present invention;

FIG. 5C shows a schematic view of a user equipment according to some embodiments of the present invention;

FIG. 5D shows a schematic view of a user equipment according to some embodiments of the present invention;

FIG. 6 shows a flowchart of a general method according to some embodiments of the present invention;

FIG. 7 shows a component view for a software module arrangement according to some embodiments of the teachings herein;

FIG. 8 shows a component view for an arrangement comprising circuits according to some embodiments of the teachings herein; and

FIG. 9 shows a schematic view of a computer-readable medium carrying computer instructions that when loaded into and executed by a controller of an arrangement enables the arrangement to implement some embodiments of the present invention.

### DETAILED DESCRIPTION

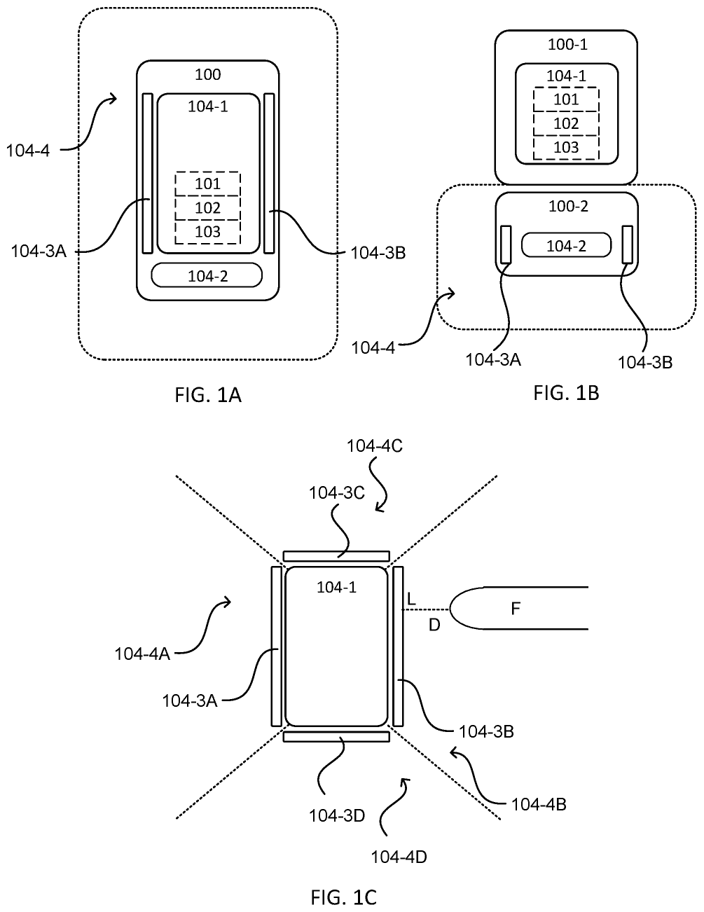

FIG. 1A shows a schematic view of a user equipment 100 according to some embodiments of the present invention. In some example embodiments, the user device 100 is a smartphone, smartwatch or a tablet computer. The user equipment 100 comprises a controller 101, a memory 102 and a user interface 104 (comprising one or more interface components 104-1-104-4 as will be discussed in detail below).

It should be noted that the user equipment 100 may comprise a single device or may be distributed across several devices and apparatuses.

The controller 101 is configured to control the overall operation of the user equipment 100. In some embodiments, the controller 101 is a specific purpose controller. In some embodiments, the controller 101 is a general purpose controller. In some embodiments, the controller 101 is a combination of one or more of a specific purpose controller and/or a general purpose controller. As a skilled person would understand there are many alternatives for how to implement a controller, such as using Field—Programmable Gate Arrays circuits, ASIC, CPU, GPU, NPU etc. in addition or as an alternative. For the purpose of this application, all such possibilities and alternatives will be referred to simply as the controller 101.

The memory 102 is configured to store data such as application data, settings and computer-readable instructions that when loaded into the controller 101 indicates how the user equipment 100 is to be controlled. The memory 102 may comprise several memory units or devices, but they will be perceived as being part of the same overall memory 102. There may be one memory unit for a display arrangement storing instructions and application data, one memory unit for a display arrangement storing graphics data, one memory for the communication interface 103 for storing settings, and so on. As a skilled person would understand there are many possibilities of how to select where data should be stored and a general memory 102 for the user equipment 100 is therefore seen to comprise any and all such memory units for the purpose of this application. As a skilled person would understand there are many alternatives of how to implement a memory, for example using non-volatile memory circuits, such as EEPROM memory circuits, or using volatile memory circuits, such as RAM memory circuits. For the purpose of this application all such alternatives will be referred to simply as the memory 102.

In some embodiments the user equipment 100 may further comprise a communication interface 103. The communication interface 103 may be wired and/or wireless. The communication interface 103 may comprise several interfaces.

In some embodiments the communication interface 103 comprises a USB (Universal Serial Bus) interface. In some embodiments the communication interface 103 comprises a HDMI (High Definition Multimedia Interface) interface. In some embodiments the communication interface 103 comprises a Display Port interface. In some embodiments the communication interface 103 comprises an Ethernet interface. In some embodiments the communication interface 103 comprises a MIPI (Mobile Industry Processor Interface) interface. In some embodiments the communication interface comprises an analog interface, a CAN (Controller Area Network) bus interface, an I2C (Inter-Integrated Circuit) interface, or other interfaces.

In some embodiments the communication interface 103 comprises a radio frequency (RF) communications interface. In one such embodiment the communication interface 103 comprises a Bluetooth™ interface, a WiFi™ interface, a ZigBee™ interface, a Z-Wave™ interface, a RFID™ (Radio Frequency IDentifier) interface, Wireless Display (WiDi) interface, Miracast interface, and/or other RF interface commonly used for short range RF communication. In an alternative or supplemental such embodiment the communication interface 103 comprises a cellular communications interface such as a fifth generation (5G) cellular communication interface, an LTE (Long Term Evolution) interface, a GSM (Global Systeme Mobile) interface and/or other interface commonly used for cellular communication. In some embodiments the communication interface 103 is configured to communicate using the UPnP (Universal Plug n Play) protocol. In some embodiments the communication interface 103 is configured to communicate using the DLNA (Digital Living Network Appliance) protocol.

In some embodiments, the communication interface 103 is configured to enable communication through more than one of the example technologies given above. The communication interface 103 may be configured to enable the user equipment 100 to communicate with other devices, such as other smartphones.

The user interface 104 comprises one or more interface components 104-1-104-4 such as one or more output devices and one or more input devices. Examples of output devices are a display arrangement, such as a display 104-1, one or more lights (not shown in FIG. 1A) and a speaker (not shown). Examples of input devices are one or more buttons 104-2, a camera (not shown) and a microphone (not shown). In some embodiments, the display arrangement comprises a touch display 104-1 that act both as an output and as an input device being able to both present graphic data and receive input through touch, for example through virtual buttons.

The user interface 104 of a user equipment 100 according to the teachings herein further comprises one or more side sensors 104-3 that are configured to detect and determine the presence of and distance to an object remotely, without contact being made. Such side sensors 104-3 enable for an extended user interface area 104-4 where touchless input may be provided. In the example of FIG. 1A there are two side sensors 104-3A and 104-3B arranged in the user equipment, one on either side of the display 104-1.

As mentioned above, the user equipment 100 may comprise a single device or may be distributed across several devices and apparatuses. While the embodiments discussed in relation to FIG. 1A shows a user equipment being a single device it should again be noted that the user equipment may comprise several devices and all embodiments are related to bot a single device user equipment and a user equipment comprising several devices.

FIG. 1B shows a schematic view of a user equipment 100 according to some embodiments of the present invention. In some example embodiments as shown in FIG. 1B, the user device 100 is a general user equipment comprising several devices. The user equipment may be a computer (laptop or desktop) 100-1 connected to or comprising a keyboard 100-2 or other input means (even for example a cursor controlling device (for example a computer mouse). Even if only two devices 100-1 and 100-2 are shown in FIG. 1B it should be noted that any number of devices may be utilized. The various devices may be comprised in one another, connected to one another, either directly or indirectly (for example connecting a cursor controlling device to a keypad which in turn is connected to a desktop computer). The connections may be internal, external and wireless and/or wired. In the discussion herein there will be made no difference how the devices 100-1 and 100-2 of the user equipment 100 are connected to one another, and it is only of interest that they are operatively connected to one another. A mention of comprising is thus to be seen as including being operatively connected, as the device forms part of the user equipment especially when in use.

One example of a user equipment 100 having two or more devices is a computer (the desktop computer being a first device 100-1) having a keyboard (being the second device 100-2) and the keyboard being arranged with the touchless user interface 104-4 for manipulating objects and commands in the vicinity of the keyboard. The keyboard thus being an example of an input device as the second device 100-2. Other examples are cursor controlling devices, such as mouse or, a joystick or a touchpad. Alternatively, a display 104-1 for a computer may be arranged with a touchless user interface 104-4 for manipulating objects and commands in the vicinity of the display. In case, the display is a touch display, the display is both an example of a display and n input device.

As in the examples of FIG. 1A, the user equipment 100 comprises a controller 101, a memory 102 and a user interface 104 as well as several other components which will not be discussed again, but reference is simply given to the disclosure above.

In some embodiments the user equipment may thus be a computer arranged to be operatively connected to a keyboard, a cursor controlling device and/or a display.

FIG. 1C shows a schematic view of components of a user equipment 100 such as the user equipment 100 of FIG. 1A or FIG. 1B, however in the example of FIG. 1B there are four side sensors 104-3A-D arranged, one on each side of the display 104-1, thereby providing an extended user interface 104-4 having four subsections 104-4A-D. Even if the example given in FIG. 1B is focused on 4 side sensors and 4 subsections, there can be variations with a different number of side sensors 103, as well as a different number of subsections.

It should be noted that a side sensor 104-3 may comprise one sensor or an array of sensors depending on the technology being used for implementing such a side sensor. Examples of technologies for implementing such side sensors are: radar sensors, light-based proximity sensors, capacitive-based proximity sensors to mention a few examples.

Utilizing such a side sensor 104-4, the user equipment 100 according to the teachings herein is enabled to determine that an object, such as a user's finger F, is at a distance D from a location L relative the display 104-1 as shown in FIG. 1B.

For the purpose of the teachings herein, all sensors will be treated as one sensor 104-3 providing an extended user interface area for touchless input, hereafter referred to as a touchless input area 104-4.

In some embodiments where the display 104-1 is a touch screen, the combination of a touch screen 104-1 and the side sensor 104-3 thus provides for a combined interface area having one portion for touch input (the touch display 104-1) and one portion for touchless input (the touchless input area 104-4).

In some embodiments the touchless input area 104-4 is assigned to applications or processes that are executing as top or active applications. In some embodiments the touchless input area 104-4 is assigned to applications or processes that are executing as background applications. In some embodiments the touchless input area 104-4 is assigned to at least one application or process that is executing as background application and at least one application or process that is executing as an active application. As is known a user equipment 100 is able to execute an application in an active (or top) mode or in a background mode. An application being executed in an active mode, is assigned at least a portion of the display for providing graphical output and most of the buttons 104-2 of the user equipment 100, including any virtual buttons being displayed on the display 104-1 if the display 104-1 is a touch screen. An application being executed in a background mode, however, is at best only assigned a fraction of the display space if at all any space and normally no controls at all. Controlling such a background application often requires that the background application is activated and made into an active—or top—application, whereby any other application being executed as an active (top) application will have to be paused, as has been discussed above in the background section. Alternatively, the background application may be controlled by pulling up a specific control window which requires multiple inputs and obscures the currently executing active application(s)

However, the user equipment 100 according to the present teachings is configured to receive input regarding applications also through the touchless input area 104-4. As stated above, the side sensor 104-3 is able to determine the distance D to an object F. It is thus possible to determine an activation of a command, such as a (touchless) press by determining that the distance D to an object falls under a threshold distance. Furthermore, also as stated above, the side sensor 104-3 is able to determine the Location L of an object F relative the side sensor. It is thus possible to assign different commands or controls to different locations along the display 104-1. In this manner, the user interface 104 is expanded and allows for providing more user controls without obscuring or interfering with the display space assigned to an active application.

As the side sensor 104-3 is able to determine a location and a distance, the side sensor 104-3 is also able to determine or detect a gesture being made by the detected object, and the touchless user interface 104-4 may thus be used also for receiving gesture-based input, wherein a gesture is associated with an action, such as a command to be executed.

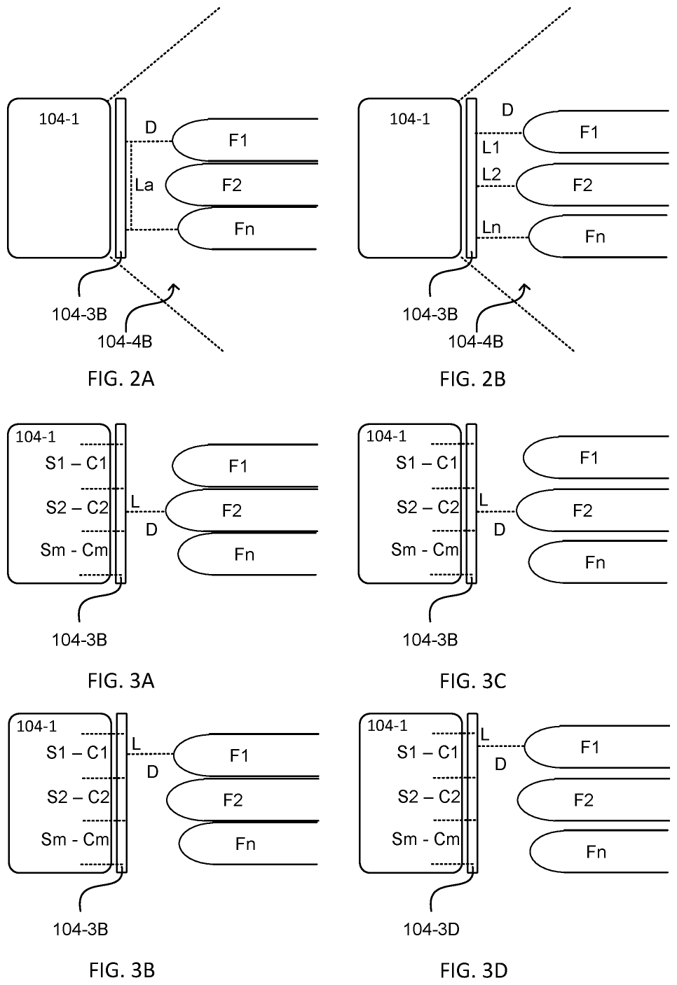

FIG. 2A shows the user equipment 100 of FIGS. 1A and 1B where the controller 101 in combination with the side sensor(s) 104-3 is configured to detect multiple objects F1, F2, Fn and to determine the number of the objects.

In some embodiments the controller is configured to determine a location area corresponding to where the object(s) is/are detected. In this embodiment, multiple objects may be detected even if presented as single object, such as when being held together.

The size of the location area La is determined and compared to a known size of an object. Based on this comparison the number of objects is easily determined.

In some embodiments, the known size of the object is a default size. In some embodiments, the known size of the object is a calibrated size, such as by being input or measured, of a user's object.

FIG. 2B also shows the user equipment of FIGS. 1A and 1B where the controller 101 in combination with the side sensor(s) 104-3 is configured to detect multiple objects F1, F2, Fn and to determine the number of the objects in an alternative or additional manner.

In some embodiments the controller 101 is configured to detect multiple objects F1, F2, Fn and to determine a location each for the detected object(s).

A combination of the embodiments disclosed in relation to FIGS. 2A and 2B allows for a combination where some objects are held together while others are separated.

It should be noted that even though the description herein is showing three objects, this is only one example and any number of objects is possible, be it 2, 3, 4, 5 or more.

In some embodiments, the object is a user's finger. In some embodiments, the object is a stylus or pen. In some embodiments on object is a stylus or pen and further object(s) is/are a user's finger(s). This provides for a user to use a stylus for input for one application and by placing one or more fingers alongside the stylus being able to control a different application.

In some embodiments, the side sensor(s) (either themselves or in combination with the controller) is able to differentiate between a stylus (or other object) and a finger. This can be utilized to not only differentiate based on the number of fingers (or objects) that is being used but also the type of objects. For example, if a stylus and a finger is used, then one application may be associated, and if two fingers are used another application may be associated.

In some embodiments, the order of the different types of objects/fingers may be utilized to associate different association. For example, by holding a stylus between thumb and index finger, may be associated with one application, whereas holding the stylus between index and long finger may be associated with another application.

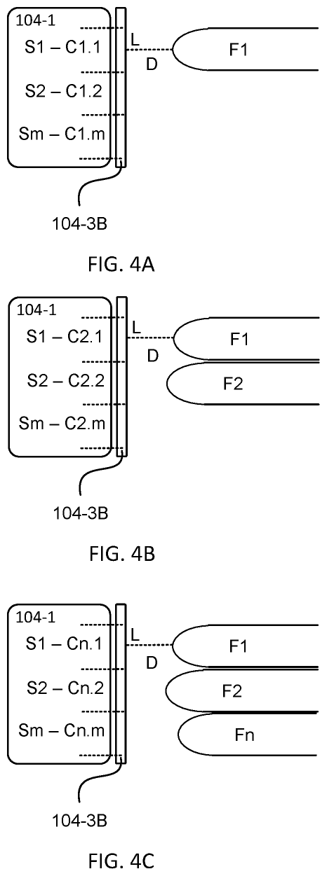

FIG. 3A shows the user equipment 100 of FIGS. 1A, 1B and 2A, where different commands have been assigned to different portions of the touchless input area 104-4. In this example there are three commands C1-C3 that are assigned to each a portion P1-P3 of the touchless input area 104-4. By the user equipment 100 determining within which portion P1-P3 the object being detected as being at a distance falling under the threshold distance, it is possible to determine which command C1-C3 to execute. In some embodiments the different commands C1-C3 relate to the same application. In some embodiments there is at least one command associated with a first application and at least one command associated with a second application. In one such embodiment, where there is a first and a second application, the first application is associated with a first portion of the touchless input area 104-4 and the second application is associated with a second portion of the touchless input area 104-4, wherein the commands associated with each application is assigned to a sub-portion of the portion of the corresponding application. For example, in the example of FIG. 1C, the first application is assigned portions P1 and P2, and the commands C1 and C2 are associated with the first application and the second application is assigned portion P3 and the command C3 is associated with the second application.

It should be noted that the size of the portions as well as location and/or distribution of portions need not be equal or regular, and any distribution is possible.

In order to provide an intuitive and easy to remember user interface that is simple to use, the user equipment 100 according to the teachings herein is configured to enable a user to setup the touchless input area 104-4.

Also shown in FIG. 3A is how a location L is determined for a group of detected objects. In some embodiments the location L is taken to be the middle of the group of objects. In one such embodiment, the middle is determined as being the middle of the area location L. In an alternative embodiment the middle is taken to be the center of the middle object.

As it is possible to determine the distance D to an object a variance in distance may also indicate the number of objects. In such some embodiments, the number of minima for the distance D corresponds to the number of objects.

It is thus also possible to determine the location of a middle object even when the objects are held together, by determining the location of a middle object.

In case of an even number of objects where two objects will be in the middle, the location of the middle object is seen as the center between two middle objects, alternatively the middle object will be the top of the two middle objects.

FIG. 3B shows an alternative where the location of the group of objects is taken as the top object.

In this context a top object is seen as the upper-most detected object in relation to the screen 104-1.

FIGS. 3C and 3D show the corresponding situation of how to determine the location L for a group of individually detected objects, where FIG. 3C shows the selection of the middle object as the object determining the location L and FIG. 3D shows the selection of the top object as the object determining the location L.

By detecting which subsection the location L corresponds to a subsection may be determined.

By detecting and determining that the distance D to the detected object(s) falls under a threshold distance, a selection of a subsection can be detected.

It is thus possible to determine which subsection S1, S2, Sm (m indicating the number of subsections) that a user is indicating and selecting, thereby enabling the user equipment to execute an associated action such as executing a command C1, C2, Cm associated with the subsection.

As indicated, the touchless input area 104-4 is arranged to have at least one subsection. For the context of the teachings herein, no difference will be made between the touchless input area 104-4 and sub-sections, unless specifically specified. A subsection may also have further subsections associated with it.

In the example of FIGS. 3A to 3D there are three subsections shown, but as should be understood, any number of subsections is possible starting from 1 (or even 0) of subsections being associated with commands for an application. In the case of zero subsections, only gesture input is possible for that application.

As discussed above, the controller 101 is configured to not only detect a group of objects, but also to determine the number of objects in that group. The controller 101 is thus configured to determine the number of detected objects.

As has also been indicated above, the controller 101 is configured to associate a first application with a first number (for example 1) of objects and associate a second number of objects (for example 2) with a second application. The controller 101 is thus configured to be able to associate the commands for the subsections with the application associated with the number of objects detected, thereby changing what command is executed if a press at a location is detected depending on the number of objects making the selection movement.

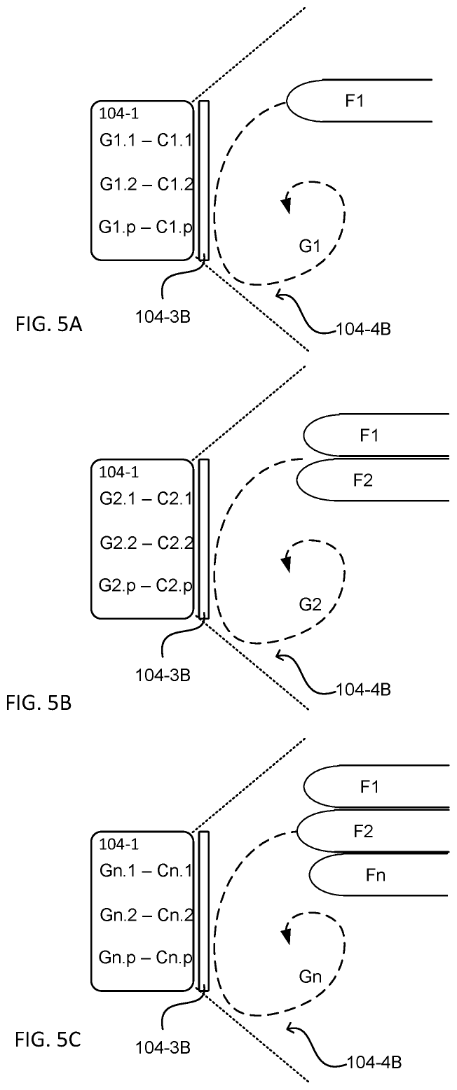

FIG. 4A shows a schematic view of a user equipment 100 as in FIG. 1A where a first number of, in this case one, object F1 has been detected. The subsections S1, S2 and Sm are associated with commands (or actions) for a first application, the commands being exemplified as C1.1 (first command for first application), C1.2 (second command for first application) and C1.m (m:th command for first application). As m is the number of available subsections, m is also the number of available commands.

FIG. 4B shows a schematic view of a user equipment 100 as in FIG. 4A where a second number of, in this case two, objects F1, F2 has been detected. The subsections S1, S2 and Sm are then associated with commands (or actions) for a second application, the commands being exemplified as C2.1 (first command for second application), C2.2 (second command for second application) and C2.m (m:th command for second application).

And FIG. 4C shows a schematic view of a user equipment 100 as in FIGS. 4A and 4B where a third number of, in this case n, objects F1, F2 Fn has been detected. The subsections S1, S2 and Sm are then associated with commands (or actions) for an n:th (or further) application, the commands being exemplified as C2.1 (first command for n:th application), C2.2 (second command for n:th application) and C2.m (m:th command for n:th application).

It should be noted that the number of subsections m may be different from application to application. The first application may thus have a different number of subsections associated with it than the second application.

As was discussed for figured 4A, 4B and 4C, the controller 101 is configured to associate a first application with a first number (for example 1) of objects and associate a second number of objects (for example 2) with a second application. As has also been indicated above, the controller 101 is able to detect a gesture being input or provided by a user utilizing the detected objects.

The controller 101 is thus configured to also or alternatively be able to associate detected gestures with different applications and commands for those applications based on the number of objects detected, thereby changing what command is executed if a gesture G is detected depending on the number of objects making the gesture G.

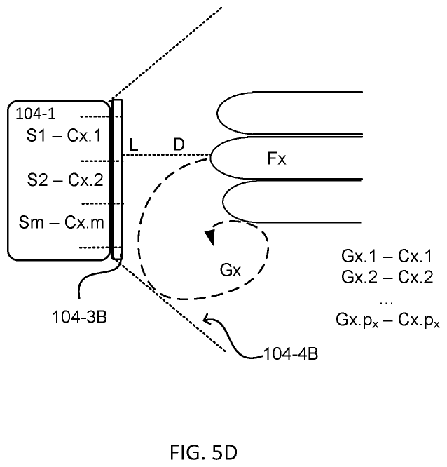

FIG. 5A shows a schematic view of a user equipment 100 as in FIG. 1A (and also FIG. 4A) where a first number of, in this case one, object F1 has been detected. The available gestures are associated with commands (or actions) for a first application, indicated graphically by a table of gestures and associated commands; the gestures and commands being exemplified as G1.1-C1.1 (first command for first gesture for first application), G1.2-C1.2 (second command for second gesture for first application) and G1.p-C1.p (p:th command for p:th gesture for first application). The number p is the number of available gestures for a given application and p is also the number of available commands for the given application. The number p may thus be different from application to application or be the same.

FIG. 5B shows a schematic view of a user equipment 100 as in FIG. 5A where a second number of, in this case two, objects F1, F2 has been detected. The available gestures are associated then with commands (or actions) for a second application; the gestures and commands being exemplified as G2.1-C2.1 (first command for first gesture for second application), G2.2-C2.2 (second command for second gesture for second application) and G2.p-C2.p (p:th command for p:th gesture for second application).

And FIG. 5C shows a schematic view of a user equipment 100 as in FIGS. 5A and 5B where a third number of, in this case n, objects F1, F2 Fn has been detected. The available gestures are associated then with commands (or actions) for a second application; the gestures and commands being exemplified as Gn.1-Cn.1 (first command for first gesture for n:th application), Gn.2-Cn.2 (second command for second gesture for n:th application) and Gn.p-Cn.p (p:th command for p:th gesture for n:th application).

It should be noted that some or all of the gestures for the different applications may be the same gesture where a same gesture causes a different command to be executed for a different application based on the number of fingers making the gesture. G1.X may thus be equal to G2.X (X being 1 to n) (gestures for first application same as gestures for second application).

FIG. 5D shows a schematic view of a user equipment 100 as in a combination of any of FIGS. 4A to 4C and any of FIGS. 5A to 5C where the controller 101 is configured to both assign subsections to commands from one or more applications and to receive gesture input for one or more applications.

It is thus possible to execute different commands for different applications based on the number of objects used for providing the input. As indicated by the subscript x for the numbering of gestures p (i.e. px) each application may have a different number of commands associated with it and they do not all or even some need to have the same number of associated commands.

It should be noted that no specific additional input is required to select or otherwise indicate the application for which the command is meant. It should also be noted that the number of objects indicate an application to be used, not a command to be given.

It should also be noted that the number of applications n may be different from implementation or setup to implementation or setup. It should also be noted that even if n is exemplified as 3 in FIGS. 4C and 5C, it may be any number as discussed above.

It should also be noted that even if the first number was exemplified as one, it could be any other number and even if the second number was exemplified as two, it could be any other number.

In some embodiments the first application is an application (or process) that is executing as a top or active application. In some embodiments the first application is an application (or process) that is executing as a background application. In some embodiments the second application is an application (or process) that is executing as a top or active application. In some embodiments the second application is an application (or process) that is executing as a background application. In some embodiments the n:th application is an application (or process) that is executing as a top or active application. In some embodiments the n:th application is an application (or process) that is executing as a background application.

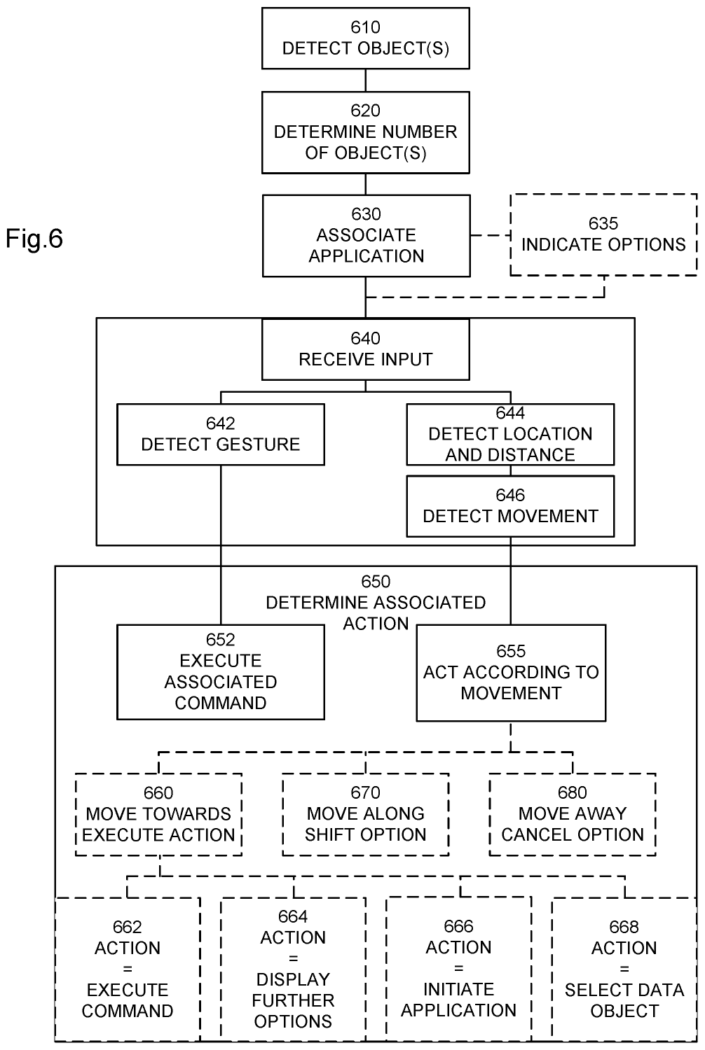

FIG. 6 shows a flowchart for a general method according to herein to be executed by a controller 101 of the user device of any previous or subsequent embodiment. The controller 101 detects 610 that one or more objects are in the touchless input area 104-4. In some embodiments, the controller 101 is further configured to determine that at least one of the detected objects is a finger of a user. In some embodiments, the controller 101 is further configured to determine that at least one of the detected objects is a stylus or pen of a user. The controller 101 determines 620 the number of objects detected and determines 630 an associated application that will be the target application for any input received by the detected objects. In an alternative embodiment (as discussed below) options are indicated 635.

The controller 101 thereafter receives input 640 and determines 650 an associated action for the associated (target) application. The input received will thus (potentially) cause different commands to be given for different applications based on the number of objects used.

The input may be received 640 by detecting 642 a gesture, whereby the determined associated action 650 will be to execute 652 a command associated with the gesture, the command being for the application associated with the number of objects.

The input may also or alternatively be received 640 by detecting a location and distance 644 of the detected object(s) and detecting 646 a movement of the detected object(s), whereby the determined associated action 650 will be to act 655 according to the detected movement, such as by selecting a command associated with the detected location as the detected distance falls under a threshold value, the command being for the application associated with the number of objects.

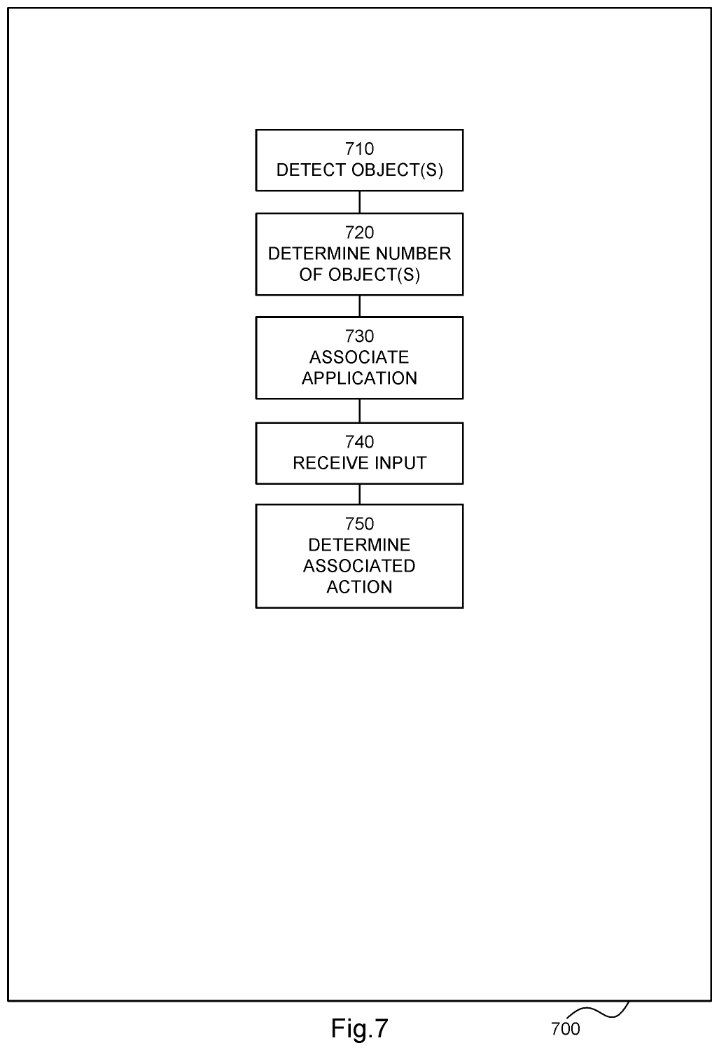

FIG. 7 shows a component view for a software module (or component) arrangement 700 according to some embodiments of the teachings herein. The software module arrangement 700 is adapted to be used in a user equipment 100 as taught herein and for enabling the user equipment 100 to execute a method according to FIG. 3. The software module arrangement 700 comprises a software module for detecting 710 a group of objects F in the touchless input area 104-4; a software module for determining 720 a number of objects in the group of objects; a software module for determining 730 an application associated with the number of objects; a software module for receiving input 740 based on the detected group of objects F; and a software module for determining an action 750 associated with the input for the application associated with the number of objects.

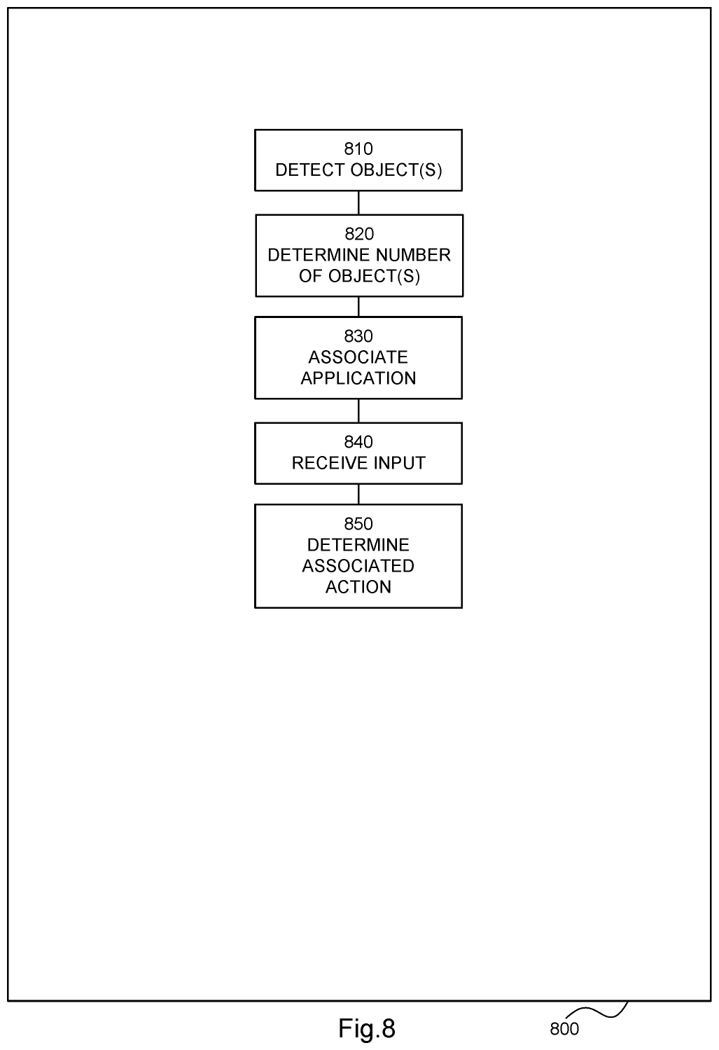

FIG. 8 shows a component view for an arrangement 800 comprising circuitry. The arrangement comprising circuitry is adapted to be used in a user equipment 100 as taught herein and for enabling the user equipment 100 to execute a method according to FIG. 3. The arrangement 800 comprises circuitry for detecting 810 a group of objects F in the touchless input area 104-4; circuitry for determining 820 a number of objects in the group of objects; circuitry for determining 830 an application associated with the number of objects; circuitry for receiving input 840 based on the detected group of objects F; and circuitry for determining an action 850 associated with the input for the application associated with the number of objects.

Further details on possible use of the touchless interface will be given below with simultaneous reference to the patent application filed concurrently herewith and entitled “A COMPUTER A SOFTWARE MODULE ARRANGEMENT, A CIRCUITRY ARRANGEMENT, A USER EQUIPMENT AND A METHOD FOR AN IMPROVED AND EXTENDED USER INTERFACE” by the same applicant. It should be noted that corresponding circuitry as well as software modules for the features discussed below (and otherwise herein) are considered to be included in the shown modules and circuits even if not explicitly shown.

As discussed in relation to previous figures the side sensor 104-3 is enabled to detect an object(s) (such as a user's finger) F and the location L and distance D to the display of the object(s). In order to provide an extended user interface that does not interfere with the ongoing execution and/or presentation of a currently executed application, i.e. the top application, the inventors have realized and devised a highly intuitive menu interactions system which allows for providing many, almost endless, options of controls while not interfering with the top application. Such menu interaction system is highly useful for executing and/or controlling background application and/or for providing system controls for the user equipment 100, general controls or specific controls. In addition to associating the number of objects to an application. Also, by such association multiple background applications may be controlled in addition to a top application. For example using a single object will control a top application whereas using multiple fingers will control (different) background application(s)—as based on the number of objects

Some examples are if a user wishes to control volume settings or other controls for a music player application running in the background while playing a car driving game, to handle an incoming call without interrupting the car driving game, quick replies to messages, and/or controlling connected devices (such as media devices (TV), or other smart home devices).

The menu system may also be utilized to execute, and eventually initiate, another top application without interfering with the current top application by treating the second top application as a background application.

Some examples are if a user wishes to select a specific music file to be played (i.e. to look through the music library other than by skipping to next song) for a music player application running in the background while playing a car driving game, to set up and handle an outgoing call to a specific contact without interrupting the car driving game, and/or to switch connection settings without interrupting the car driving game or other application being executed.

In order to accomplish this, the user equipment is configured to detect that an object, such as a user's finger, F is within the touchless input area 104-4 by the controller 101 receiving data indicating this from the side sensor 104-3. The controller 101 also determines which portion the object F is within of the touchless input area 104-4. In some embodiments, the controller is configured to determine that the object is within the touchless input area 104-4 by determining that the distance D is below an initial threshold distance.

As the object has been detected, the controller 101 is, in some embodiments, configured to indicate at least one menu option associated with the portion that object F is within. In some embodiments, the controller is also configured to indicate that the portion is associated with a menu or array of commands, by indicating the corresponding portion on the display 104-1 for example by providing feedback. The feedback may be visual (graphic and/or lights) and/or audio. The feedback may indicate that a subsection S1 is associated with a menu, and also the extent of the menu.

Regardless of the feedback, the controller 101 is configured to indicate at least one menu option associated with the portion that object F is within. In this context, a menu option may be a control command, a menu traversal command (up/back/next, . . . ), a further menu option and/or an application. Hereafter they will all be referred to as options.

In some embodiments, the options are only displayed once it is determined that the object F is moved closer to the display 104-1. In one context, “closer” refers to a distance shorter than the distance at which the object was when the feedback was displayed. In one context, “closer” refers to a distance falling below a first threshold distance. It should be noted that the two contexts may be combined, perhaps where the distance of the first context (the distance at which the object was when the feedback was displayed) defines the threshold distance.

The options are preferably displayed in a manner where they are substantially transparent so that they do not obscure the content being displayed at the same position on the display 104-1. They are also displayed as being transparent, by the controller treating any input received in a display area overlapped by the graphical representation of an option as being an input for the underlying content, i.e. for the current top application.

It should be noted that the options may not need be displayed and the displaying of such options could be a user setting, and a user could simply learn by heart where an option is located without needing to see the option being displayed.

It should also be noted that the options may be presented, alternatively or additionally through audio output providing indication(s) of the option(s).

In some embodiments, the option is simply displayed as an indication for guiding the user to the location of the option, which is useful in situations where the user has memorized the order of the options but perhaps not the exact locations. Each option may be associated with a sub-portion.

In some embodiments, the controller 101 is further configured to indicate which option would be selected currently if a selection was made, i.e which option is the user currently deemed to hover over. The marking can be through highlighting an option, change the size of the option, change the color of the option, change the symbol of the option and/or any combination thereof. The controller is further configured to determine that the object F is moved in a direction parallel to the display 104-1 (i.e. up or down in the plane of the display), and in response thereto, indicate another option being currently selectable.

The controller 101 is further configured to determine that the object F is moved closer to the display 104-1, thereby receiving a selection of the option at the location of the object, and in response thereto execute an action associated with the option currently being selectable.

The associated action depends on what type the option is. For example, the action for an option being a menu traversal option would be to execute the menu traversal (up/down/. . . ), the action for an option being a command would be to execute the command, the action for an option corresponding to a deeper menu level would be to open the deeper or further menu level, thereby displaying at least one further option. The further option(s) may display in addition to the previous options, and/or instead of the previous options.

The controller 101 may also be configured to determine that the object is moved away from the display and in response thereto return to a higher menu level. This thus allows for traversal of a menu structure of options, without interfering substantially with an executing top application.

In some embodiments the controller 101 has detected that the object has moved closer to the display, and in response thereto execute the action associated with the selected option and where the action is to execute a command. In this example the command is to increase the volume settings for the user equipment 100.

In the example given herein, the volume is increased by pushing a virtual touchless button. However, other variants exist for such increase/decrease commands. One example being to select a function option (by moving towards the display), and then move the finger up to increase and down to decrease the associated function. Examples of functions can be related to volume, brightness, scrolling, toggle on/off switches, and adjust settings to mention a few examples.

As an action has been performed, the controller 101 may be configured to continue display the currently displayed options, even when it is detected that the finger is moved away slightly (to a next distance interval) from the display. This allows for further selections of options. Alternatively or additionally, the controller is configured to stop displaying all options.

The controller 101 is also configured to stop displaying all options if it is determined that the object is moved away from the display, wherein no more options are displayed. However, the effect of any commands having been executed is still applicable.

In some embodiments the controller 101 is configured to determine that the object F is moved away from the display when the object is at a distance falling above the initial threshold distance.

In some embodiments the controller 101 is configured to determine that the object is moved away from the display when the object F is no longer detectable.

In some embodiments the controller 101 is further arranged to track an object F in order to ensure that a command is only activated when the object is coming close to the display 104-1. This safeguards against accidental activation of an action/command simply by the user changing a grip or another object coming into close proximity. Such a situation could easily occur when manipulating a user equipment 100 while seated in a moving vehicle, such as a train carriage or a bus.

A threshold range is seen as the range between and possibly including thresholds relevant to the distance(s) in question.

It should be noted that even though the figures herein are displaying three options (at a time) it should be noted that any number of options to display is possible and depends on the number of options available, the size of the subsections, the size of the display 104-1 and the size of the indications.

Returning to FIG. 6, in some embodiments the controller 101 is configured to indicate 635 that at least one option is available for selection as the object F is detected. This may be done by indicating the extent of a menu structure and/or by displaying at least one option, or rather display graphical representations for the at least one option.

An option being at a location corresponding to the object (such as corresponding to the location of a tip of a finger) is considered as a selectable option. In some embodiments, the controller 101 is configured to indicate which option that is currently selectable.

As discussed above the controller 101 is configured to detect 646 a movement of the object F and act 655 accordingly.

When the movement is detected to be towards the user equipment 100, such as when the distance to the object falls below a threshold value, the controller 101 is configured to act by performing or executing 660 an action associated with the currently selectable option, i.e. the option being displayed at a location corresponding to where the distance to the object falls below the threshold distance.

When the option is associated with a command, the controller 101 is configured to execute 662 such a command. In some embodiments the controller is further configured to receive further input regarding the command and then executing based on the further input (such as moving up to increase, down to decrease as discussed above).

When the option is associated with further options, such as for displaying further options in a menu structure, the controller 101 is configured to display 664 the further options.

When the option is associated with an application to be initiated, the controller 101 is configured to initiate 666 the application.

When the option is associated with a data object, the controller is configured to select 668 the data object and possibly execute an associated command. One example of a data object is a contact, and an associated action could be to initiate a communication with the contact.

This allows for providing a manner of traversing a menu structure and/or a complete user interface structure, where further options may be displayed, commands and functions may be executed, applications may be initiated and data objects may be selected.

When the movement is detected to be along or parallel to the user equipment 100, the controller 101 is configured to determine 670 a new selectable option corresponding to a new location of the object, i.e to shift the option.

When the movement is detected to be away from the user equipment 100, the controller 101 is configured to stop 680 displaying the at least one option, i.e. to cancel the at least one option.

Other variants and alternatives area also possible for the various functions as discussed in the above. Some of these alternatives will be discussed below, and it should be noted that they may all, some or each be combined with the embodiments discussed in the above as suitable and compatible.

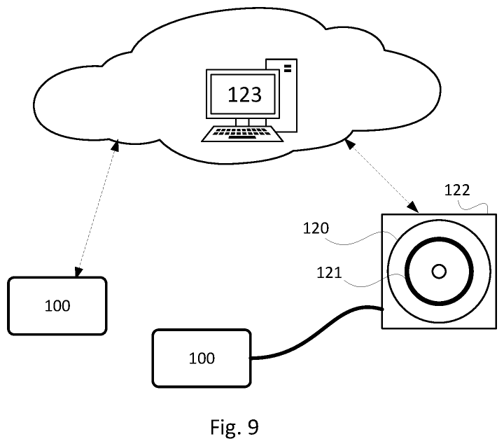

FIG. 9 shows a schematic view of a computer-readable medium 120 carrying computer instructions 121 that when loaded into and executed by a controller of a user equipment 100 enables the user equipment 100 to implement the present invention.

The computer-readable medium 120 may be tangible such as a hard drive or a flash memory, for example a USB memory stick or a cloud server. Alternatively, the computer-readable medium 120 may be intangible such as a signal carrying the computer instructions enabling the computer instructions to be downloaded through a network connection, such as an internet connection.

In the example of FIG. 9, a computer-readable medium 120 is shown as being a computer disc 120 carrying computer-readable computer instructions 121, being inserted in a computer disc reader 122. The computer disc reader 122 may be part of a cloud server 123—or other server—or the computer disc reader may be connected to a cloud server 123—or other server. The cloud server 123 may be part of the internet or at least connected to the internet. The cloud server 123 may alternatively be connected through a proprietary or dedicated connection. In some example embodiments, the computer instructions are stored at a remote server 123 and be downloaded to the memory 102 of the user equipment 100 for being executed by the controller 101.

The computer disc reader 122 may also or alternatively be connected to (or possibly inserted into) a user equipment 100 for transferring the computer-readable computer instructions 121 to a controller 101 of the user equipment 100 (presumably via a memory 102 of the user equipment 100).

FIG. 9 shows both the situation when a user equipment 100 receives the computer-readable computer instructions 121 via a server connection and the situation when another user equipment 100 receives the computer-readable computer instructions 121 through a wired interface. This enables for computer-readable computer instructions 121 being downloaded into a user equipment 100 thereby enabling the user equipment 100 to operate according to and implement the invention as disclosed herein.

1. A user equipment comprising at least one side sensor and a controller,
wherein the side sensor is configured to receive touchless user input, thereby providing a touchless input area, and wherein the controller is configured to:
detect a group of objects WPM in the touchless input area;
determine a number of objects in the group of objects;
determine an application associated with the number of objects;
receive input based on the detected group of objects; and
determine an action associated with the input for the application associated with the number of objects.

2. The user equipment according to claim 1, wherein the controller is configured to determine a first number of objects and associate the first number of objects with a first application and to determine a second number of objects and associate the second number of objects with a second application.

3. The user equipment according to claim 1, wherein the at least one side sensor is configured to differentiate between different types of objects and wherein the controller is further configured to
determine a type of objects in the group of objects;
determine the application associated with the number of objects and with the type of object.

4. The user equipment according to claim 3, wherein the controller is further configured to
determine an order of two types of objects in the group of objects;
determine the application associated with the number of objects, the type of object and with the order of objects.

5. The user equipment according to claim 1, wherein at least one object in the group of detected objects is a finger.

6. The user equipment according to claim 1, wherein at least one object in the group of detected objects is a stylus or pen.

7. The user equipment according to claim 1, wherein the controller is further configured to determine the number of objects in the detected group of objects by determining a location area for the detected groups of objects.

8. The user equipment according to claim 1, wherein the controller is further configured to determine the number of objects in the detected group of objects by detecting at least one individual object.

9. The user equipment according to claim 1, wherein the controller is further configured to
receive the input by detecting a gesture and to
determine the associated action by executing a command associated with the detected gesture for the application associated with the number of objects.

10. The user equipment according to claim 1, wherein the controller is further configured to receive the input by
detecting a location and a distance for the detected group of objects and
detecting a movement of the detected group of objects and
to determine the associated action by
acting for the application associated with the number of objects according to the detected movement.

11. The user equipment according to claim 10, wherein the controller is further configured to act for the application associated with the number of objects according to the detected movement by:
performing an action associated with the option being displayed at a location corresponding to the object when the movement is detected to be towards the user equipment
determining a new option corresponding to a new location of the object when the movement is detected to be along the user equipment;
cancelling at least one option when the movement is detected to be away from the user equipment; and
by executing a command when the option is associated with such a command.

12. The user equipment according to claim 1, wherein the user equipment comprises a display, and wherein at least one of the at least one side sensor is arranged adjacent the display, wherein the side sensor is configured to receive touchless user input at a side of the display, thereby providing the touchless input area at the side of the display.

13. The user equipment according to claim 1, wherein the user equipment comprises an input device, and wherein at least one of the at least one side sensor is arranged adjacent the input device, wherein the side sensor is configured to receive touchless user input at a side of the input device, thereby providing the touchless input area at the side of the input device.

14. The user equipment according to claim 1, wherein the user equipment comprises the side sensor by being operatively connected to it.

15. The user equipment according to claim 1, wherein the user equipment is a smartphone, smartwatch or a tablet computer.

16. The user equipment according to claim 1, wherein the user equipment is a computer being arranged to be operatively connected to a keyboard, a cursor controlling device and/or a display.

17. A method for use in a user equipment comprising at least one side sensor configured to receive touchless user input, thereby providing a touchless input area, and
wherein the method comprises:
detecting a group of objects in the touchless input area;
determining a number of objects in the group of objects;
determining an application associated with the number of objects;
receiving input based on the detected group of objects; and
determining an action associated with the input for the application associated with the number of objects.

18. A non-transitory computer-readable medium carrying computer instructions that when loaded into and executed by a controller of a user equipment enables the user equipment to implement a method for use in the user equipment, wherein the user equipment comprises at least one side sensor configured to receive touchless user input, thereby providing a touchless input area, and wherein the method comprises:
detecting a group of objects in the touchless input area;
determining a number of objects in the group of objects;
determining an application associated with the number of objects;
receiving input based on the detected group of objects; and
determining an action associated with the input for the application associated with the number of objects.

19. (canceled)

20. An arrangement adapted to be used in a user equipment comprising a display, at least one side sensor configured to receive touchless user input at a side of the display, thereby providing a touchless input area, and said arrangement comprising:
circuitry for detecting a group of objects WPM in the touchless input area;
circuitry for determining a number of objects in the group of objects;
circuitry for determining an application associated with the number of objects;
circuitry for receiving input based on the detected group of objects; and
circuitry for determining an action associated with the input for the application associated with the number of objects.
